(19) United States
(12) Patent Application Publication
(10) Pub. No.: US 2014/0349536 A1
(43) Pub. Date: Nov. 27, 2014

(54) Carbon Nanotube Heat Storage Textile, And Preparation Method Thereof

(71) Applicant: TOP NANOSYS, INC, Gyeongsangbuk-do (KR)

(72) Inventors: Yong Sung Jo, Seoul (KR); Sang Keun Oh, Gyeonggi-do (KR)

(21) Appl. No.: 14/357,004

(22) PCT Filed: Feb. 23, 2012
(86) PCT No.: PCT/KR2012/001374

§ 371 Date: Aug. 1, 2014

(30) Foreign Application Priority Data
Nov. 11, 2011 (KR) 10-2011-0117280

(51) Int. Cl. D06M 11/74; B05D 3/14; C08K 3/04; C08K 5/13; C08K 5/41; C09K 5/14; C09D 175/04

(52) U.S. Cl. CPC D06M 11/74; C09K 5/14; B05D 3/145; C09D 175/04; C08K 5/13; C08K 5/41; C08K 3/04; C08K 2003/045; Y10S 977/752
USPC 442/136; 428/221; 427/343; 427/535; 524/334; 524/156; 977/752

(57) ABSTRACT

A heat storage textile. In one embodiment the textile is prepared by applying a coating containing carbon nanotubes to a side of a textile. The coating solution comprises, by weight, at least 0.1% carbon nanotubes, 0.01% dispersant, 9.89% resin binder, and 10 solvent. The carbon nanotube surface may be modified to improve the adhesive properties. The carbon nanotubes can be single wall nanotubes, multi-wall carbon nanotubes such as a double wall nanotube (DWNT), or thin multi-wall nanotubes. The coating may cure while transferring the coated heat storage textile with a constant velocity at a room temperature or in a heated chamber.

### RELATED APPLICATION

This application is the National Stage Application which claims priority to International Application No. PCT/KR2012/001374 filed on Nov. 11, 2011.

### FIELD OF THE INVENTION

The present invention relates to heat storage and thermal insulation in textile products. More specifically, the invention relates to textiles having coatings comprising carbon nanotubes which coatings exhibit heat storage and thermal insulation effects, and preparation methods for manufacture of such textiles.

### BACKGROUND

Fabric textiles which absorb and store heat therein are advantageous, particularly, for clothing, curtains, sofas and the like because these heat storage and thermal insulation effects can reduce heating expenditures and lead to a more pleasant living environment. In the past, many efforts have been made to develop fibers or textiles having a heat storage or thermal insulation functions.

Korean Patent Laid-Open Publication No. 2001M097022 discloses a product having heat storage and thermal insulation effects produced by impregnating a textile or cloth with a phase changing composition. Further, Korean Patent Laid-Open Publication No. 2002M059047 discloses a heat storage and thermal insulation textile haying a multilayer structure and a method for preparing a heat storage and thermal insulation textile, which comprises forming an adhesive layer on a base textile, forming a thermal-insulating foam layer thereon, forming a heat-absorbing layer thereon, and heat-treating the resulting material.

In recent years, Mitsubishi Rayon Co., Ltd. (Japan) developed and sold Corebrid-B® composed of acrylic short fibers that have a core-shell structure containing wood charcoal particles in the core. The acrylic short fibers function to absorb solar light to exhibit a warming effect. De Sante Inc. and Teijin Fiber Co. Ltd. (Japan) jointly developed a special flat cross-sectional fiber (commercially available under the trade name of Heat Navi) comprising a carbon-based inorganic material that functions to absorb solar light to exhibit a warming effect. The fiber is applied mainly to outdoor clothing. However, these prior art technologies have shortcomings in that a complicated fiber spinning process for incorporating light-absorbing particles into fiber yarns is required. This increases production costs, in part because the light-absorbing particles have a small surface areas and, consequently, a large number of the light-absorbing particles are incorporated to provide uniform warming. in other words, in the prior art technologies, the production cost increases, but heat storage and thermal insulation effects are not exhibited.

Accordingly, the present inventors have contemplated that carbon nanotubes having a large surface area and a high light absorptivity can provide heat storage and thermal insulation effects to realize improved heat storage in textile products.

Carbon nanotubes (CNTs) are nanomaterials in which graphite sheets composed of carbon atoms arranged into a hexagonal honeycomb are rolled up into tubes having a diameter ranging from about several nanometers to several hundreds of nanometers. Carbon nanotubes show peculiar electrical, mechanical and physiochemical properties due to their special electronic structure resulting from the configuration and the nanometer-order diameter. For example, carbon nanotubes Show a strength that is at least 100 times higher than that of steel while having a density of ½ of that of aluminum. In addition, carbon nanotubes have a large surface area per unit mass due to their small dimensions, and thus have a large active area for absorbing energy and can provide stable mixed materials due to a very high interaction with mixed materials. Due to their excellent physical properties, carbon nanotubes are being actively used in various industrial applications, including structural reinforcing materials, fuel cells, sensors and the like. Particularly, carbon nanotubes are known to be very excellent in terms of light absorption.

It was reported that a vertically grown carbon nanotube array has a total reflectivity of 0.045%, which is at least 3 times lower than that of a material known to date to have the lowest reflectivity (Zu-Po Yang et al., “Experimental Observation of an Extremely Dark Material Made by a Low-Density nanotube Array”, NANO LETTERS, 2008 Vol. 8, No. 2, pp 446-451, 2008). Thus, the vertically grown carbon nanotube array is a black body having the lowest reflectivity among materials known to date.

In consideration of the above-described characteristics of carbon nanotubes, the present inventors have developed a novel heat storage textile having excellent light absorbing properties and which converts the absorbed light to heat. The textile can be produced at low costs by preparing a coating solution containing carbon nanotubes having a large surface area and a high light absorptivity, and coating the surface of the textile with the coating solution.

### SUMMARY OF THE INVENTION

The present invention enables provision of a textile having excellent heat storage and thermal insulation effects. Excellent heat storage and thermal insulation effects can result from carbon nanotubes contained in the textile. In one embodiment, a low cost textile is provided which has excellent heat storage and thermal insulation effects that result from multi-walled carbon nanotubes contained in the textile. Because the textile may contain multi-walled carbon nanotubes among carbon nanotubes, it can be produced at low costs. There is also provided a method for preparing a textile that has excellent heat storage and thermal insulation effects as a result of containing multi-walled carbon nanotubes. A heat storage textile comprising carbon nanotubes according an embodiment of the present invention is characterized in that it is prepared by coating one or both surfaces of a textile with a coating solution containing carbon nanotubes. The coating solution may comprise 0.1-15 wt % of carbon nanotubes (CNTs), 0.01-5 wt % of a dispersant, 9.89-70 wt % of a resin binder, and 10-90 wt % of a solvent. The coating solution may further comprise an additive in an amount of 0.01-5 parts by weight based on 100 parts by weight of the coating solution. The coating solution may be applied to the textile surface directly or after mixing with a polyurethane resin binder.

The carbon nanotubes are preferably subjected to a surface modification process in order to improve their adhesion with the resin binder and the dispersion thereof

The carbon nanotubes that are used in the present invention may be single-walled carbon nanotubes (SWNTs), but are preferably multi-walled carbon nanotubes (MWNTs) such as double-walled carbon nanotubes (DWNTs) or thin multi-walled carbon nanotubes (thin MWNTs).

The coating solution may be coated on the textile surface by gravure coating, offset coating, kiss bar coating, knife coating, Mayer bar coating, comma coating, roll coating, dip coating or spray coating. When the coating solution is coated by knife edge coating using a knife, the distance between the knife and the textile is preferably maintained in the range from 0.01 min to 0.1 mm. Other coating methods are also performed so as to provide results similar to those of the knife edge coating method.

The coating solution applied to the texture is cured at room temperature or in a heated chamber.

The present invention provides a textile that has excellent heat storage and thermal insulation effects as a result of containing carbon nanotubes. Particularly, the present invention provides a textile that contains multi-walled carbon nanotubes among carbon nanotubes, and thus is produced at low costs and has excellent heat storage and thermal insulation effects.

### BRIEF DESCRIPTION OF THE DRAWINGS

The present invention is described with reference to the accompanying drawings, wherein:

FIG. 1 shows a heat storage textile having a surface formed with a coating solution containing multi-walled carbon nanotubes in accord with an Example 1;

FIG. 2 shows a heat storage textile having a surface formed with a coating solution containing multi-walled carbon nanotubes in accord with an Example 2;

FIG. 3 shows a heat storage textile having a surface formed with a coating solution containing single-walled carbon nanotubes in accord with an Example 3;

FIG. 4A is a view in cross section illustrating a textile used in fabrication of the invention;

FIG. 4B illustrates a heat storage textile according to the invention; and

FIG. 5 illustrates a heat storage textile according to another embodiment of the invention.

### DETAILED DESCRIPTION OF THE INVENTION

The present invention relates to a heat storage and thermal insulation textile having a coating on a side or surface thereof comprising a carbon nanotube composition capable of exhibiting heat storage and thermal insulation effects, and a preparation method thereof.

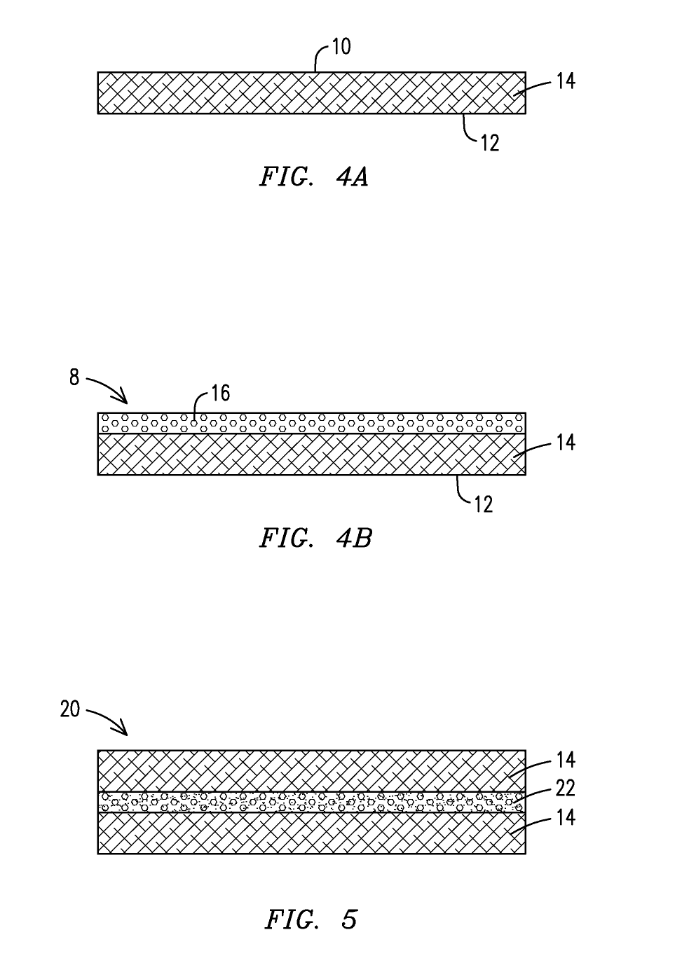

With reference to FIGS. 4A and 4B, a heat storage textile 8 comprising carbon nanotubes is prepared by coating one or both sides 10, 12 of a layer of a textile 14 with a coating 16 containing carbon nanotubes.

The heat storage textile 8 may be applied to manufacture various types of outdoor clothing that require thermal insulation properties, as well as sporting goods, leisure goods such as mountain climbing or fishing goods, military uniforms, and indoor curtains or sofas.

Thus, textiles that may be used in the present invention include those made of synthetic fiber yams or natural fiber yams. Typical examples of the fiber yams include cotton, polyester, nylon, acrylic and acetate yams, which may be used alone or in a mixture to prepare textiles.

As illustrated in the figures, the inventive textile 8, having heat storage and thermal insulation characteristics, is prepared by coating at least one side 10 of the layer of the textile 14 with a coating containing carbon nanotubes.

The coating may comprise 0.1-15 wt % of carbon nanotubes (CNTs), 0.01-5 wt % of a dispersant, 9.89-70 wt % of a resin binder, and 10-90 wt % of a solvent. The coating may further comprise an additive in an amount of 0.01-5 parts by weight based on 100 parts by weight.

The carbon nanotubes that are used in the present invention may be single-walled carbon nanotubes (SWNTs), but are preferably multi-walled carbon nanotubes (MWNTs) such as double-walled carbon nanotubes (DWNTs) or thin multi-walled carbon nanotubes (thin MWNTs).

Single-walled carbon nanotubes (SWNTs) may be used to prepare the carbon nanotube-containing coating, but are expensive. in the present invention, in order to overcome this problem of single-walled carbon nanotubes, a test was performed using multi-walled carbon nanotubes and, as a result, it was found that multi-walled carbon nanotubes have excellent heat storage and thermal insulation effects. In addition, multi-walled carbon nanotubes are inexpensive, unlike single-walled carbon nanotubes, and thus make it possible to produce the heat storage textile at lower costs. In the present invention, double-walled carbon nanotubes (DWNT) and thin multi-walled carbon nanotubes (thin MWNT) may all be used, because they all show excellent heat storage effects and are also inexpensive. The content of carbon nanotubes in the coating solution is preferably in the range from 0.1 wt % to 15 wt %. If the content of carbon nanotubes is less than 0.1 wt %, there may not be sufficient heat storage and thermal insulation characteristics, and if the content of carbon nanotubes is more than 15 wt %, there may be an unacceptable cease in the production cost because an unnecessarily large amount of carbon nanotubes are used,

The carbon nanotubes are preferably subjected to a surface modification process in order to improve their adhesion with the resin binder and the dispersion thereof The method for modifying the surface of carbon nanotubes is a conventional method, such as liquid or vapor acid treatment, ozone water treatment or plasma treatment. This conventional method for modifying the surface of carbon nanotubes can be easily carried by those skilled in the art to which the present invention pertains.

The carbon nanotubes in the coating solution should be uniformly and finely dispersed in order to increase the light absorption area and, for this purpose, a dispersant or a surfactant is added to the coating solution. The dispersant used in embodiments of the present invention may be a commercially available conventional surfactant, and examples thereof include SDS, SDBS, SDSA, DTAD, CTAB, NaDDBS, cholic acid, Tween 85, Brij 78, Brij 700, Triton X, PYP, EC (ethyl cellulose), Nafion, HPC (hydroxy propyl cellulose), CMC (carboxy methyl cellulose), HEC (hydroxy ethyl cellulose), Pluronic (PEO-PPO copolymer) and the like. These dispersants may be used alone or in a mixture of two or more.

The content of the dispersant in the coating solution is in the range from 0.01 wt % to 5 wt %. If the content of the dispersant is less than 0.01 wt %, it will not show sufficient dispersibility, and if it is more than 5 wt %, an unnecessarily large amount will undesirably be used.

In order to guarantee adhesion to fibers and washing fastness, a resin binder is used in the coating solution. Examples of the resin binder include thermosetting binders and UV-curable binders. Preferably, the binder that is used in the present invention may be one member, or a mixture of two or more members, selected from the group consisting of urethane-based resin, acrylic resin, an urethane-acryl copolymer, polyimide, polyamide, polyester-based resin, polyolefinic resin and melanin-based resin. The resin binder may be used in the coating solution in an amount of 9.89-70 wt %, and the kind and amount of resin binder used can be readily determined by those skilled in the art in consideration of the relationship with other components.

The above-described carbon nanotubes, dispersant and resin binder are mixed with each other in a solvent to form a coating. The solvent used in the present invention may be one member, or a mixture of two or more members, selected from the group consisting of water and organic solvents, including methanol, ethanol, ethyl acetate, acetone, methyl ethyl ketone (MEK), toluene, and dimethylformamide (DMF), but the solvent is not limited thereto. The solvent may be used in an amount of 10-90 wt % in the coating containing the carbon nanotubes, the dispersant and the resin binder.

In addition to the carbon nanotubes, the dispersant and the resin binder, various additives may be added to the coating in order to impart stability or specific required functions to the solution. Examples of additives that are added to the coating solution include a dispersing agent, a slip agent, a flowability-improving agent, a thickener, an antistatic agent, a water repellent, an agent fur permeating air, water vapor and sweat, and an UV stabilizer, which may be used alone or a mixture of two or more additives. It is to be understood that additives used in the present invention are not limited to the above-described additives and other suitable additives may be used. The additives may be added in an amount of 0.01-5 parts by weight based on 100 parts by weight of the coating. The coating may be applied to the textile surface directly or after mixing with a polyurethane resin binder.

The coating may be coated on the textile surface, e.g., the side 10, by gravure coating, offset coating, kiss bar coating, knife coating, Mayer bar coating, comma coating, roll coating, dip coating or spray coating. When the coating is applied by knife edge coating using a knife, the distance between the knife and the textile is preferably maintained in the range from 0.01 mm to 0.1 mm. Other coating methods are also performed. so as to provide results similar to those of the knife edge coating method.

The coated heat storage textile 8 is at room temperature or in a heated chamber at a predetermined speed while the coating solution applied thereto is cured. The coating method or the post-coating curing process conditions, that is, the chamber temperature, the transfer speed of the textile in the chamber, and the like, may be modified depending on the kind or specification of textile, and this modification can be easily achieved by those skilled in the art.

A heat storage textile 20 comprising carbon nanotubes according to another embodiment of the present invention is characterized in that it is prepared by laminating textiles 14 to each other by a bonding process using a mixture 22. of an adhesive and the carbon nanotube-containing coating 16. In this case, the kind or amount of adhesive used can be readily determined. by those skilled in the art.

Hereinafter, the present invention will be described in father detail by examples, and these examples are for illustrative purposes only and are not intended to limit the scope of the present invention.

### EXAMPLES

### Example 1

Preparation of Coating

In a process of preparing a carbon nanotube-containing coating according to the present invention, the surface of MWNTs was oxidized with a mixed solution of nitric acid and sulfuric acid (3:1) to prepare MWNTs having improved dispersibility. 5 wt % of the acid-treated MWNTs, 5 wt % of a dispersant (trade name: Triton X100), 0.2 wt % of a defoaming agent (trade name: Surfynol 104H) and 38.8 wt % of distilled water were mixed with each other, and the mixture was ultrasonically treated with a power of 140 W (70%) for 1 hour to disperse the MWNTs. To the dispersion, 50 wt % of a water-dispersed polyurethane-based binder (trade name: Sancure 12954) and 1 wt % of a thickener (trade name: Carbopol EP-1) were added, and the mixture was stirred with a stirrer for 30 minutes, thereby preparing a coating.

Preparation of Heat Storage Textile

The above-prepared carbon nanotube-containing coating was applied on the back side 10 of a 100% polyester textile (region indicated by reference numeral 3 in FIG. 1) by a knife edge coating method using a knife while maintaining the distance between the knife and the textile surface at 0.05 mm, and then the coating was cured at room temperature.

### Comparative Example 1

A region indicated by reference numeral 1 in FIG. 1 was coated with the coating, prepared as described above but containing no carbon nanotubes, by a knife edge coating method using a knife While maintaining the distance between the knife and the textile surface at 0.05 mm, and then the coating in region 1 was cured at mom temperature.

A region indicated by reference numeral 2 in FIG. 1 was not coated with anything so that the portion of Comparative Example 1 corresponding to the region 1 of FIG. 1 could be easily distinguished from the portion of Example 1 corresponding to the region 3 of FIG. 1.

Observation with Heat Image Camera

The test sample comprising the regions coated by the methods of Example 1 and Comparative Example 1 shown in FIG. 1 was photographed with a heat image camera. The change in the temperature of the textile surface was observed while irradiating IR rays at a distance of 30 cm from a 500 W near infrared lamp. The results of the observation indicated that the temperature of the carbon nanotube-coated textile (region 3) was increased by a maximum of 28° C. compared to those regions of the non-coated textile and the textile coated with the coating solution containing no carbon nanotubes.

### Example 2

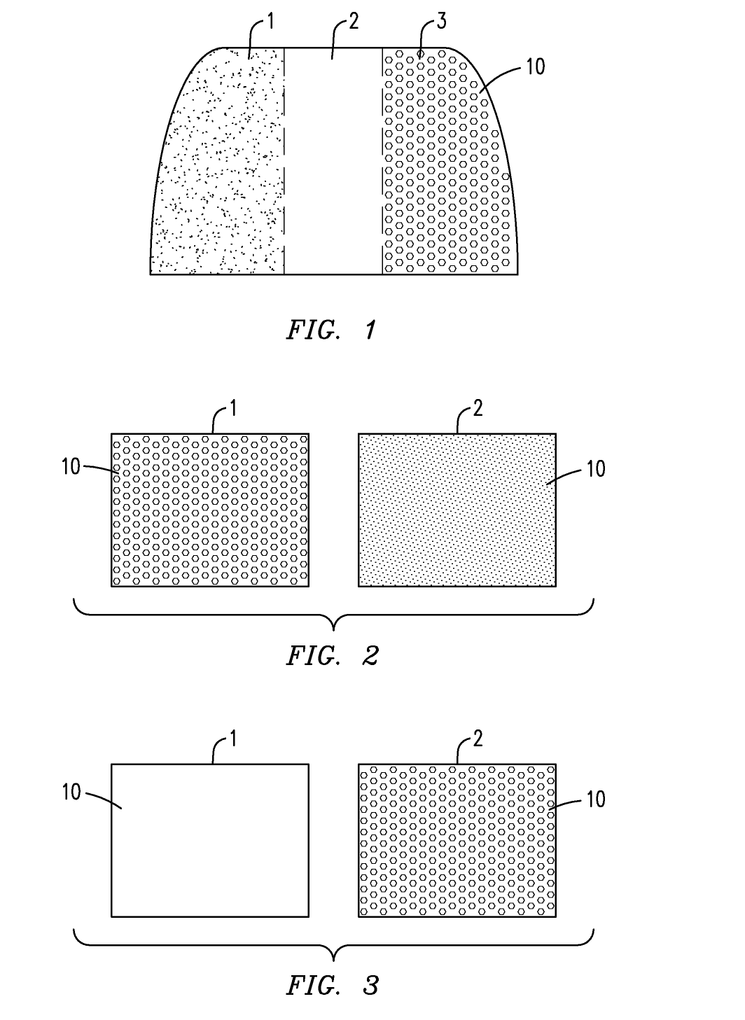

The carbon nanotube-containing coating prepared according to the method of Example 1 was applied on a side 10 in textile sample region (10 cm×10 cm) indicated by reference numeral 1 in FIG. 2, and a heat storage textile was prepared in the same manner as described in Example 1.

### Comparative Example 2

For comparison with Example 2, a black dye-containing ink was coated on the side 10 in a textile sample region (10 cm×10 cm) indicated by reference numeral 2 in FIG. 2, thereby preparing a test sample.

Observation with Heat Image Camera

The test sample comprising the regions coated by the methods of Example 2 and Comparative Example 2 was photographed with a heat image camera in the same manner as described in Example 1. The results of the observation indicated that the temperature of the carbon nanotube-coated textile (region 1) was increased by a maximum of 26° C. compared to that of the ink-coated texture (region 2).

### Example 3

To prepare carbon nanotubes, the surface of SWNTs treated by an arc discharge method oxidized with a mixed solution of nitric acid and sulfuric acid (3:1) to prepare SWNTs having improved dispersibility. 0.5 wt % of the acid-treated SWNTs, 5 wt % of a dispersant (SDS), 0.2 wt % of a defoaming agent (Surfynol 1041-1) and 43.3 wt % of distilled water were mixed with each other, and the mixture was ultrasonically treated with a power of 140 W (70%) for 1 hour to disperse the SWNTs. To the dispersion, 50 wt % of a water-dispersed polyurethane-based binder (Sancure 12954) and 1 wt % of a thickener (Carbopol EP-1) were added, and the mixture was stirred with a stirrer for 30 minutes, thereby preparing a coating. The coating was applied in a region 2 on a side 10 on a 10 cm×10 cm textile sample to prepare a test sample.

Observation with Heat Image Camera

The change in the temperature of the textile surface in the region 2 on the side 10 was observed with a heat image camera while irradiating IR rays at a distance of 30 cm from a 500 W near infrared lamp at room temperature. Reference numeral 1 in FIG. 3 is a region not covered with the coating, and reference numeral 2 is a region covered with the coating solution of Example 3. The results of the observation indicated that the temperature of the SWNT-coated textile indicated by reference numeral 2 was increased by a maximum of 24° C. compared to that of the non-coated textile region indicated by reference numeral 1.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1-16. (canceled)

17. A method of preparing a heat storing textile comprising applying to at least a first side of the textile carbon nanotubes to produce a textile having formed thereon a layer containing heat storing carbon nanotubes.

18. The method of claim 1 wherein the step of applying the carbon nanotubes includes:
forming the carbon nanotubes in a coating comprising by weight at least 0.1 percent carbon nanotubes, at least 0.01 percent dispersant and at least 10 percent solvent; and
applying the coating to the first side of the textile.

19. The method of claim 2 wherein the step of forming includes incorporating into the coating resin binder material in an amount of at least 9.89 percent by weight,

20. The method of claim 3 wherein the coating is formulated to comprise 0.1-15 percent by weight carbon nanotubes, 0.01-5 percent by weight dispersant, 9.89-70 percent by weight resin binder and 10-90 percent by weight solvent.

21. The method of claim 2, wherein the step of forming the coating further comprises:
surface-treating said carbon nanotubes through one or more methods taken from the group consisting of liquid or vapor acid treatment, ozone water treatment and plasma treatment.

22. The method of claim 5 wherein surface-treating said carbon nanotubes improves
adhesion with said resin and improves dispersion within said coating.

23. The method of claim 2 in which said coating further comprises one or more additional additives taken from the group consisting of a slip agent, a flowability-improving agent, a thickener, an antistatic agent, a water repellent, an agent for permeating air and an UV stabilizer.

24. The method of claim 1 in which said coating comprises multi-walled carbon nanotubes.

25. The method of claim 1 in which said textile comprises one or more yarns taken from the group consisting of natural fiber yarns, including cotton and wool yarns, and synthetic fiber yarns including polyester, nylon, acrylic and acetate yarns.

26. A coating for preparing a carbon nanotube textile, comprising 0.1-15 percent by weight carbon nanotubes, 0.01-5 percent by weight dispersant, 9.89-70 percent by weight resin binder and 10-90 percent by weight solvent.

27. The coating of claim 10 further comprising multi-walled carbon nanotubes.

28. The coating of claim 10, further comprising one or more additional additives taken from the group consisting of a slip agent, a flowability-improving agent, a thickener, an antistatic agent, a water repellent, an agent for permeating air, water vapor and sweat, and an UV stabilizer.

29. The coating of claim 10 in which said resin binder includes one member of or a mixture of two or more members selected from the group consisting of a urethane-based resin, an acrylic resin, an urethane-acryl copolymer, a polyimide, a polyamide, a polyester-based resin, a polyolefinic resin and a melanin-based resin,

30. The coating of claim 10 in which said solvent is one member of or a mixture of two or more members selected from the group consisting of water and organic solvents, including methanol, ethanol, ethyl acetate, acetone, methyl ethyl ketone, toluene and dimethylformamide.

31. A textile comprising:
a layer of textile material; and
a coating containing carbon nanotubes formed on at least one side of the textile layer, the combination of the layer and coating characterized by an improved heat storage property or an improved thermal insulation property relative to the layer of textile without the coating formed thereon.

32. The textile of claim 15 wherein the coating further includes a dispersant and a resin binder.

33. The textile of claim 15, wherein said coating further comprises one or more additives selected from the group consisting of a dispersing agent, a slip agent, a flowability-improving agent, a thickener, an antistatic agent, a water repellent, an agent for permeating air, water vapor and sweat, and an UV stabilizer.

34. The textile of 15 wherein a bond exists between the coating and the textile layer.

35. The textile of claim 15 prepared by bonding at least two layers of textile with a composition comprising the coating according to claim 10 and an adhesive composition.
